(19) United States
(12) Patent Application Publication
(10) Pub. No.: US 2011/0156332 A1
(43) Pub. Date: Jun. 30, 2011

(54) TRANSFER APPARATUS AND TRANSFER METHOD

(75) Inventor: Hiroshige KISHIMOTO, Inuyama-shi (JP)

(73) Assignee: MURATA MACHINERY, LTD., Kyoto-shi (JP)

(21) Appl. No.: 12/894,208

(22) Filed: Sep. 30, 2010

(30) Foreign Application Priority Data
Oct. 9, 2009 (JP) 2009-235743

(51) Int. Cl. B23Q 1/25

(52) U.S. Cl. 269/56

(57) ABSTRACT

The present invention provides a clamp transfer device which keeps a load from incurring damage and transfers the load at a high-speed. The transfer device includes: a first member which is attached so as to rotate about an axis of rotation perpendicular to a horizontal direction in which the load is clamped, and makes contact with the load, the first member having a profile with (i) a first radius stretching from the axis of rotation to a periphery of the first member, and (ii) a second radius being shorter than the first radius; a second member which clamps the load by working together with the first member; and a first clamping mechanism which (i) rotates the first member about the axis of rotation so that a distance between an end portion of the first radius and the second member diminishes, and (ii) produces a clamping force for clamping the load.

### BACKGROUND OF THE INVENTION

(1) Field of the Invention

The present invention relates to transfer devices, used for stacker cranes and at unmanned delivery stations, picking up and transferring a load from a first storage space to a second storage space, and transfer methods performed thereby. In particular, the present invention relates to a transfer device which quickly transfers a load, and a transfer method performed thereby.

(2) Description of the Related Art

A load transfer device is mounted on a stacker crane in order to transfer a load between a rack holding the load and a stacker crane loading and unloading the load to and from the rack. Such a load transfer device is also used for a station at which a load is loaded and unloaded to and from the stacker crane, and an automated transfer vehicle transferring the load. In order to transfer a load between a first storage space and a second storage space, the following methods are exemplified: a fork mounting method which involves lifting to load a load with forks, a suction pick-up method which involves picking up a load to transfer by applying suction thereto; a pick-up belt method which involves moving a load by a pick-up belt conveyor, and a clamp method which involves clamping a load on the both sides, and transferring the load.

As shown in Patent Reference 1 (Japanese Unexamined Patent Application Publication No. 2005-138949) for example, a transfer device employing the clamp method can reduce a space which is required for loading a load but is unnecessary for storing the load; namely, a dead space.

Recently, more and more quick transfer of loads has been desired. In transferring a load quickly by a clamp transfer device, the clamp needs to travel fast. The problem is, however, that the load cannot follow up acceleration and deceleration of the traveling clamp, and the load possibly falls out of the clamp. Concurrently, more clamping force could be applied to the load in order to prevent the load from falling out. This, however, may crash the load due to the increased clamping force. In the case where a load to be transferred is a card board box, in particular, the side faces of the cardboard box are not always solid, and the card board box needs to be clamped rather firmly. This will possibly damage the load.

### SUMMARY OF THE INVENTION

The present invention is conceived in view of the above problems and has as an object to provide a clamp transfer device which keeps a load from incurring damage and transfers the load at a high-speed, and a clamp transfer method performed thereby.

In order to achieve the above object, a transfer device according to an aspect of the present invention transfers a clamped load, and includes: a first member which is attached so as to rotate about an axis of rotation perpendicular to a horizontal direction in which the load is clamped, and makes contact with the load, the first member having a profile with (i) a first radius stretching from the axis of rotation to a periphery of the first member, and (ii) a second radius being shorter than the first radius; a second member which clamps the load by working together with the first member; and a first clamping mechanism which (i) rotates the first member about the axis of rotation so that a distance between an end portion of the first radius and the second member diminishes, and (ii) produces a clamping force for clamping the load.

According to the above structure, the rotating first member works together with the second member to produce a clamping force used for clamping the load. The structure allows the load to be clamped and the clamping force to be produced above the axis of rotation. When the transfer device elevates the first member and the second member to lift the load, a downward force is produced on a point where the first member makes contact with the load. This downward force attempts to rotate the first member in a direction to enhance the clamping force (Hereinafter, this phenomenon is referred to as the “biting effect”). The biting effect exercised by the first member makes possible sudden lifting of the load, which allows the transfer device to quickly transfer the load. Here, the gravity of the load also produces the biting effect. The biting effect grows in proportion to the weight of a load. Accordingly, the transfer device can quickly transfer a load even when the transfer device transfers loads with varying weights at a certain speed.

Concurrently, the transfer device according to the aspect of the present invention also allows the load to be clamped and a clamping force to be produced below an axis of rotation. Hence, when taking down the load lifted by the first member and the second member, the transfer device can exercise the biting effect produced by the first member.

The transfer device according the aspect of the present invention may further include: a third member which (i) is placed either above or below the first member and the second member, (ii) is attached so as to rotate about an axis of rotation perpendicular to a horizontal direction in which the load is clamped, and (iii) makes contact with the load, the third member having a profile with (i) a third radius stretching from the axis of rotation to a periphery of the third member, and (ii) a fourth radius being shorter than the third radius; a fourth member which clamps the load by working together with the third member; and a second clamping mechanism which (i) rotates the third member about the axis of rotation so that a distance between an end portion of the third radius and the fourth member diminishes, and (ii) produces a clamping force for clamping the load.

This structure allows the load to be clamped on two vertically varying locations, one location by the first and the second members and the other location by the third and the fourth members. Accordingly, the transfer device can keep the load from falling and shaking. Furthermore, the transfer device can split the clamping force required to move the load unit upward and downward. Hence, the transfer device eases a stress imposed on the load, and allows the load to be stably transferred. Accordingly, the transfer device can quickly transfer the load.

The first member of the first clamping mechanism and the third member of the second clamping mechanism may rotate in opposite directions.

This structure produces the biting effect on (i) either one of the members which is set above when the load is lifted, and (ii) the other one of the members which is set below when the load is taken down. Hence, this structure is capable of exercising the biting effect throughout an operation of the transfer device, such as clamping and lifting the load, transferring the load to a predetermined position, and taking down the load. Accordingly, the transfer device can quickly transfer the load.

The transfer device according to the aspect of the present invention may further include an adjusting mechanism adjusting a distance lying between the first member and the second member.

According to the structure, the transfer device can flexibly adjust to loads having a variety of widths. Thus, the transfer device can always exercise the biting effect produced on the first member.

A transfer method which employs a transfer device that transfers a clamped load and includes: a first member which is attached so as to rotate about an axis of rotation perpendicular to a horizontal direction in which the load is clamped, and makes contact with the load, the first member having a profile with (i) a first radius stretching from the axis of rotation to a periphery of the first member, and (ii) a second radius being shorter than the first radius; and a second member which clamps the load by working together with the first member wherein the transfer method involves (i) rotating the first member about the axis of rotation in a direction so that an end portion of the first radius travels from above the axis toward the load, and (ii) producing a clamping force above the axis to clamp and transfer the load.

According to the above method, the rotating first member works together with the second member to produce a clamping force used for clamping the load. The structure allows the load to be clamped and the clamping force to be produced above the axis of rotation. When the transfer device elevates the first member and the second member to lift the load, a downward force is produced on a point where the first member makes contact with the load. This downward force attempts to rotate the first member in a direction to enhance the clamping force. The biting effect exercised by the first member makes possible sudden lifting of the load, which allows the transfer device to quickly transfer the load. Here, the gravity of the load also produces the biting effect. The biting effect grows in proportion to the weight of a load. Accordingly, the transfer device can quickly transfer a load even when the transfer device transfers loads with varying weights at a certain speed.

The present invention proposes secure clamping suitable to a travel of a transferring load, and makes possible quickly transferring the load.

### Further Information about Technical Background to this Application

The disclosure of Japanese Patent Application No. 2009-235743 filed on Oct. 9, 2009 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a perspective view of a part of an automated warehouse equipped with a stacker crane including a transfer device,

FIG. 2 is a perspective view of a clamping unit included in the transfer device having a clamped load,

FIG. 3 is an elevation view of the clamping unit included in the transfer device having the clamped load,

FIG. 4 is an elevation view cross-sectionally illustrating how the load and a first member are in contact,

FIG. 5 is an elevation view cross-sectionally illustrating how the load and a second member are in contact,

FIG. 6 is a perspective view showing a transfer device,

FIG. 7 is an elevation view conceptually showing a first clamping mechanism,

FIG. 8 is an elevation view of the transfer device before the load is clamped,

FIG. 9 is a perspective view of the clamping unit included in the transfer device having the clamped load,

FIG. 10 is an elevation view exemplifying another transfer device,

FIG. 11 is an elevation view exemplifying another transfer device, and

FIG. 12 shows variations of a profile of a member.

### DESCRIPTION OF THE PREFERRED EMBODIMENT

Described below is a transfer device according to Embodiment in the present invention.

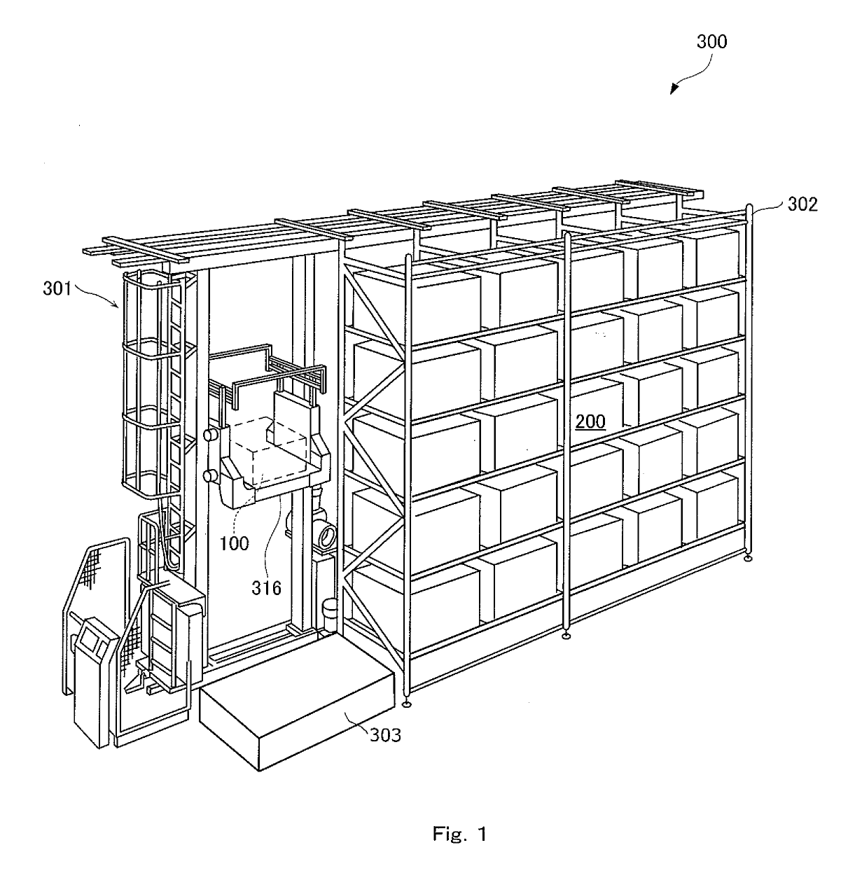

FIG. 1 is a perspective view of a part of an automated warehouse equipped with a stacker crane including a transfer device.

As shown in FIG. 1, an automated warehouse 300 has a stacker crane 301. The stacker crane 301 automatically brings in a load 200 to a rack 302 to store, and carries the load 200 out of the rack 302. The automated warehouse 300 includes the stacker crane 301, the rack 302 provided along a passageway of the stacker crane 301, and a station 303 where the load 200 is put when the load is brought in and carried out.

An elevating table 316 attached to the stacker crane 301 has a transfer device 100.

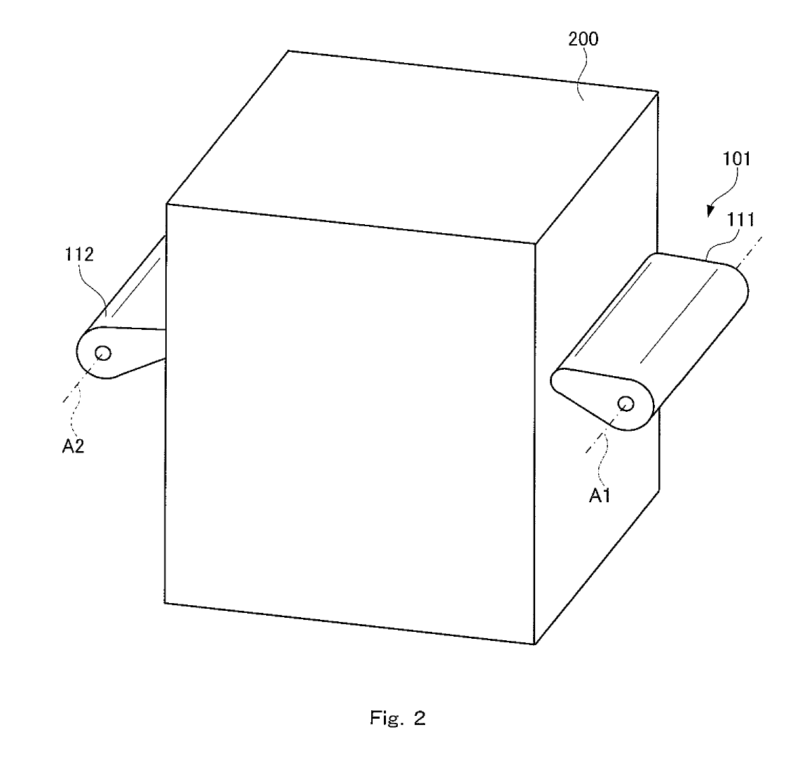

FIG. 2 is a perspective view of a clamping unit included in the transfer device 100 having the clamped load 200.

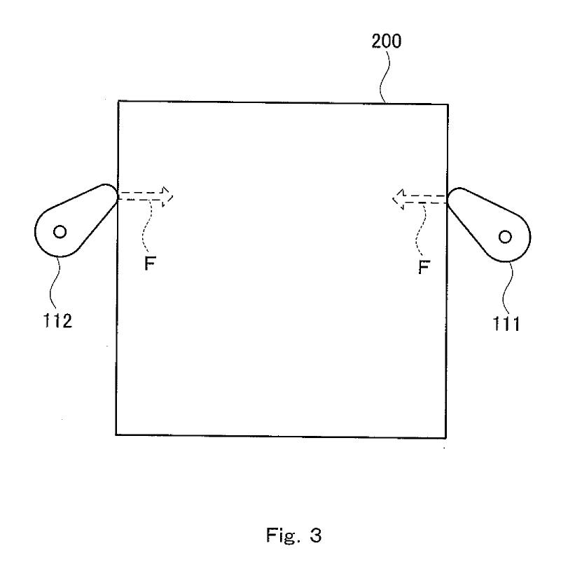

FIG. 3 is an elevation view of the clamping unit included in the transfer device 100 having the clamped load.

As shown in FIG. 2, a clamping unit 101 is a part of the transfer device 100, and directly clamps the load 200. The clamping unit 101 includes a first member 111 and a second member 112.

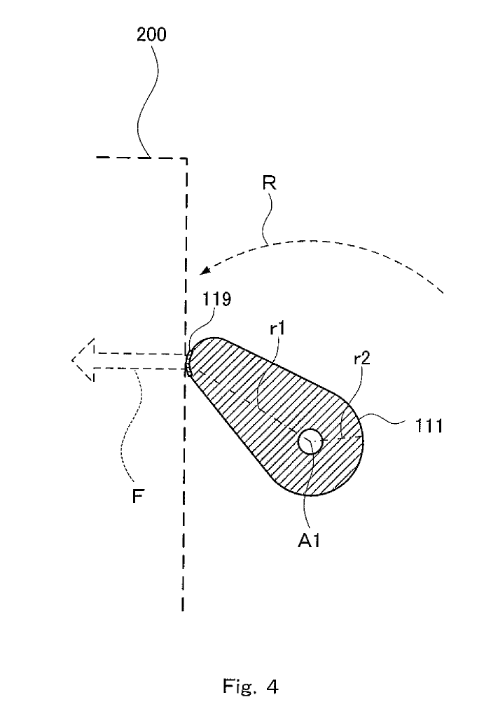

The first member 111, a rigid body, is attached so as to rotate about an axis of rotation (a dashed line in FIG. 2) perpendicular to a horizontal direction in which the load 200 is clamped (an arrow in a broken line F in FIG. 3), and makes contact with the load 200. As shown in FIG. 4, the first member 111 has a profile with (i) a first radius r1 stretching from an axis of rotation A1 to a periphery of the first member 111, and (ii) a second radius r2 which is shorter than the first radius r1. The profile faces perpendicular to the axis of the rotation A1 of the first member 111. Thus the first member 111 rotates in a direction R (an arrow in a broken line R in FIG. 4) so that an end portion of the first radius r1 moves over the axis of rotation A1 toward the load 200, and the end portion of the first radius r1 is in contact with the load 200. Hence, the first member 111 can produce a clamping force F above the axis of rotation A1. When the gravity and the inertia produce a downward force on the load 200, the downward force attempts to rotate the first member 111 in the direction R. This increases the clamping force F. In other words, the first member 111 exercises the biting effect while transferring the load 200. Here, the first radius r1 is also a radius of a locus of a predetermined point, the locus which is given when the first member 111 rotates about the axis of rotation A1. This idea is also applied to the second radius r2, as well as the n-th radius rn (n is an integer). In order for the end portion of the first radius r1 to make contact with the load 200 so as to produce the clamping force F, the first radius r1 needs to be longer than the distance between the axis of rotation A1 and the load 200. To make the first member 111 rotate smoothly until the clamping force F is produced, the second radius r2 needs to be shorter than the distance between the axis of rotation A1 and the load 200. It is noted that the load 200 is an object to be transferred, not a constituent feature of the transfer device 100. Thus the above described requirements will not be met if the load 200 is excessively large; however, even though such an excessively large load 200 is found, the present invention is still effective as far as there is a load 200 which complies with the above requirements.

In Embodiment, an anti slip member 119 is provided on a point where the first member 111 is in contact with the load 200. The anti slip member 119 increases a friction coefficient between the first member 111 and the load 200 to enhance the biting effect. Made of rubber and thus flexible, for example, the anti slip member 119 works as a cushion to the load 200, as well as increases the friction coefficient.

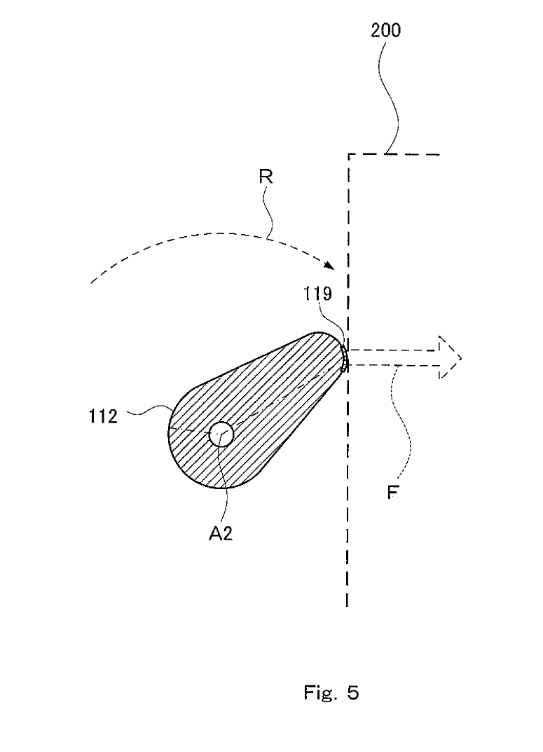

The second member 112, a rigid body, works together with the first member 111 to clamp the load. In Embodiment, the second member 112 has a profile similar to that of the first member 111 as shown in FIG. 5. Rotating about the axis of rotation A2, the second member 112 makes contact with the load 200 to produce the clamping force F. It is noted that the second member 112 and the first member 111 rotate in opposite directions.

In the above description, the first member 111 is introduced as a rigid body shaped in a solid bar; concurrently, the first member 111 shall not be limited to the structure. Instead, the first member 111 may be shaped in a hollow cylinder. In order to save weight, the first member 111 may be shaped with an unnecessary portion thereof eliminated.

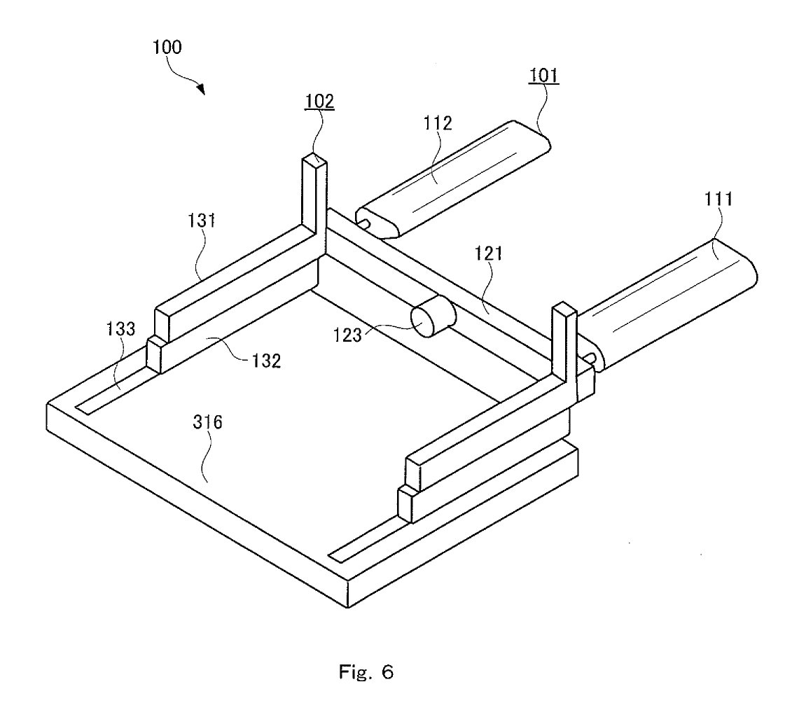

FIG. 6 is a perspective view showing a transfer device.

As shown in FIG. 6, the transfer device 100 includes a clamping unit 101, a transferring unit 102, and a first clamping mechanism 121.

The first clamping mechanism 121 rotates the first member 111 about the axis of rotation A1 so that the distance between the second member 112 and the end portion of the first radius r1 of the first member 111 diminishes. This movement produces a clamping force to clamp the load 200.

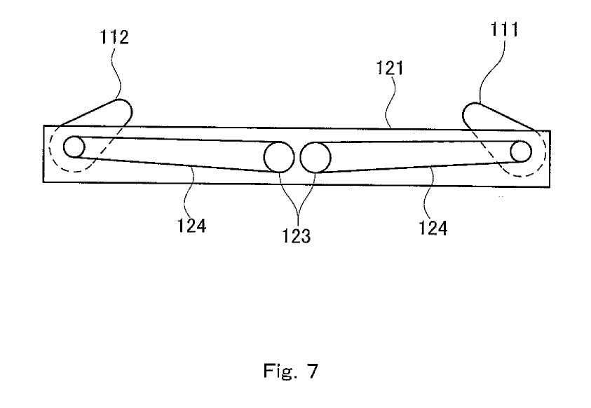

In Embodiment, as shown in FIG. 7, the first clamping mechanism 121 includes a driving mechanism 123, two chains 124, and two shafts 125 each attached to the first member 111 and the second member 112. Each of driving mechanisms 123 is equipped with a motor. The motors rotate in opposite directions. The motors and the shafts 125 rotate the first member 111 and the second member 112 in opposite directions so that the first clamping mechanism 121 can either produce the clamping force F or release the clamped load 200.

It is noted that the first clamping mechanism 121 shall not be limited to the above mechanism; instead, the first clamping mechanism 121 may employ any given mechanism, such as a combination of a shaft to be ejected and retraced from and to a cylinder and a cam, and the rack-and-pinion mechanism.

The transferring unit 102 transfers the load 200 as follows: lifting the clamping unit 101 which clamps and holds the load 200, horizontally transferring the clamping unit 101, and taking down the clamping unit 101. The transferring unit 102 includes a top arm 131, a middle arm 132, and a base arm 133.

Attached to the clamping unit 101, the top arm 131 can move the clamping unit 101 up and down. The base arm 133 is attached to the elevating table 316. The middle arm 132 slides along the base arm 133.

The middle arm 132 slidably retains the top arm 131, as well as is slidably attached to the base arm 133. Keeping predetermined structural strength, the middle arm 132 is capable of extending the top arm 131 in a distance.

The transfer device 100 according to Embodiment has a telescopic structure including the base arm 133, the middle arm 132, and the top arm 131. When a driving device (not shown) slides to extend the middle arm 132 from the base arm 133, the top arm 131 coordinates with the sliding to slide and extend from the middle arm 132.

Described next is an operation of the transfer device 100 when the transfer device 100 transfers the load 200 from the rack 302 to the elevating table 316 of the stacker crane 301.

First, the elevating table 316 moves to a position where the load 200 to be transferred is stored. Here, closely situated are (i) the surface on which the load 200 is stored, and (ii) the surface, of the elevating table 316, on which the load 200 is loaded.

Next, the middle arm 132 extends toward the rack 302 with respect to the base arm 133. In addition, the clamping unit 101 is placed in the lowest part of the top arm 131.

Coordinating with the extending middle arm 132, the top arm 131 extends toward the rack 302 with respect to the middle arm 132.

Next, when the first member 111 and the second member 112 are positioned for clamping the load 200, the extending top arm 131 stops.

Then, the first clamping mechanism 121 rotates the first member 111 so that the end portion of the first radius r1 travels toward the load 200 over the axis of rotation A1. Concurrently, the first clamping mechanism 121 rotates the second member 112 in the opposite direction of the first member 111 rotating. According to the above structure, the first member 111 and the second member 112 work together to produce the clamping force F in order to clamp the load 200.

Next, the clamping unit 101 is lifted along the top arm 131. Here, a downward force is applied to first member 111 and the second member 112 thanks to (i) the gravity of the load 200 and (ii) the inertia produced while the clamping unit 101 is accelerating. This downward force produces the biting effect.

Hence, even a sudden lift of the clamping unit 101 does not prevent the first member 111 and the second member 112 from tightly holding the load 200.

Then, the middle arm 132 slides back to the elevating table 316 with respect to the base arm 133, causing the top arm 131 to slide back to elevating table 316. Thus, this operation transfers the clamped load 200 with the clamping unit 101.

Here, the gravity of the load 200 produces the biting effect, and the load 200 is firmly clamped by the first member 111 and the second member 112. This allows the load 200 to be quickly transferred.

Once the load 200 is transferred to a predetermined position over the elevating table 316, the top arm 131 stops traveling and puts the load 200 down with the clamping unit 101.

Finally, the first clamping mechanism 121 rotates the first member 111 and the second member 112 to release the load 200.

The above operation transfers the load 200. In Embodiment, even though the bottom of the load 200 would hit so hard on the elevating table 316 when the clamping unit 101 goes down, the gravity of the load 200 decreases due to the inertia. Furthermore, since the elevating table 316 receives the load 200, an inverted biting effect is produced to decrease the clamping force F. Accordingly, the load 200 is gently placed on the elevating table 316. This keeps the load 200 from excessive damage.

Described below is a transfer device according to Modification according to Embodiment in the present invention.

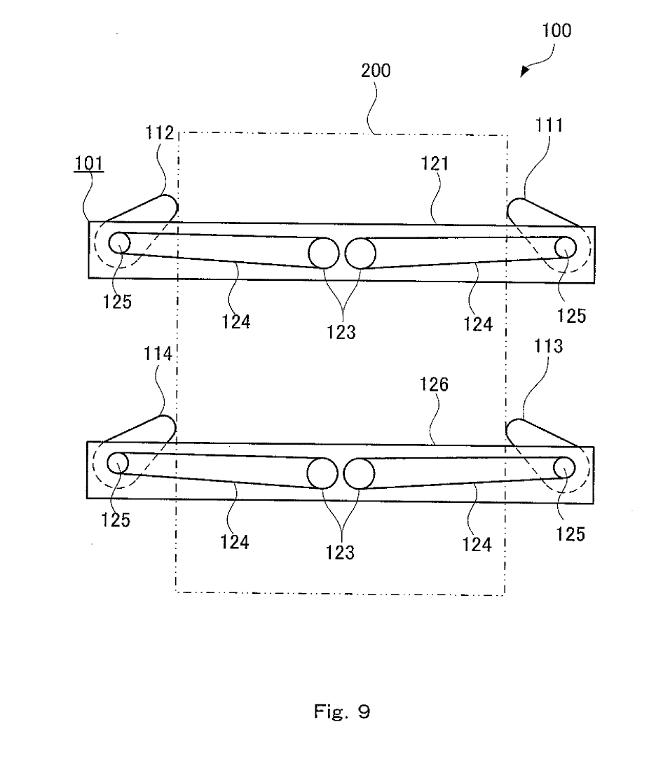

FIG. 9 is a perspective view of the clamping unit included in the transfer device having the clamped load 200.

As shown in FIG. 9, the transfer device 100 includes a third member 113, a fourth member 114, and a second clamping mechanism 126. Here, the third member 113 has the following features: placed below the first member 111 and the second member 112, making contact with the load 200, and attached to rotate about an axis of rotation (not shown) perpendicular to a horizontal direction; namely, a direction in which the load 200 is clamped. Also, the profile of the third member 113 has (i) a third radius (not shown) stretching from the axis of rotation to a periphery of the third member 113, and (ii) a fourth radius (not shown) which is shorter than the third radius. The fourth member 114 works together with the third member 113. The second clamping mechanism 126 rotates the third member 113 about the axis of rotation so that the distance between the fourth member 114 and an end portion of the third radius is diminished. This movement produces a clamping force to clamp the load 200.

In Embodiment, third member 113, the fourth member 114, and the second clamping mechanism 126 are equivalent to the first member 111, the second member 112, and the first clamping mechanism 121, respectively. Thus the details thereof shall be omitted.

Since clamping the load 200 on several points, the transfer device 100 according to the other Embodiment keeps the load 200 from falling and shaking. In particular, the transfer device 100 can stably transfer an oblong (tall) load. Furthermore, the transfer device 100 can split the clamping force F required to move the load 200 upward and downward. This structure eases a stress imposed on the load 200, and allows the load 200 to be stably transferred. Accordingly, the transfer device 100 can quickly transfer the load 200, causing no damage thereto.

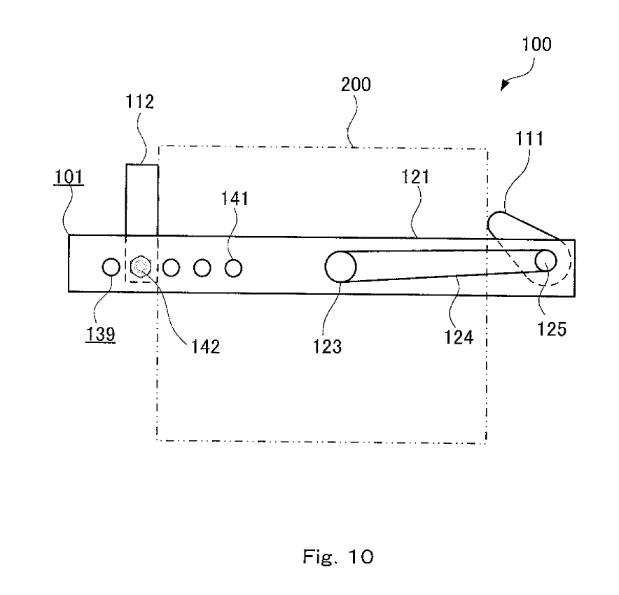

It is noted that the present invention shall not be limited to the above Embodiments. As shown in FIG. 10, for example, the second member 112 may be a rigid body shaped in a bar, and unrotatable. Here, the rotation of the first member 111 can produce the clamping force F between the first member 111 and the second member 112. The first member 111 can produce the biting effect, as well. Thus, the structure in FIG. 10 can provide the functions and the effects of the present invention. It is noted that when the unrotatable second member 112 extends to the side of the load 200 or retracts from the load 200, the second member 112 may be moved in a direction away from the load 200 in order to prevent friction from generating between the load 200 and the second member 112. For example, the first clamping mechanism 121 may slide in a clamping direction so that the load 200 can be positioned between the standing first member 111 and the second member 112. The second member 112 may be moved by an adjusting mechanism 139 below.

In addition, the adjusting mechanism 139 may be provided to adjust the distance between the first member 111 and the second member 112. In Modification according to Embodiment, the adjusting mechanism 139 includes bolt-holes 141 and a bolt 142 screwed into the second member 112. The distance between the first member 111 and the second member 112 can be adjusted with the bolt 142 to be screwed into a different bolt hole 141.

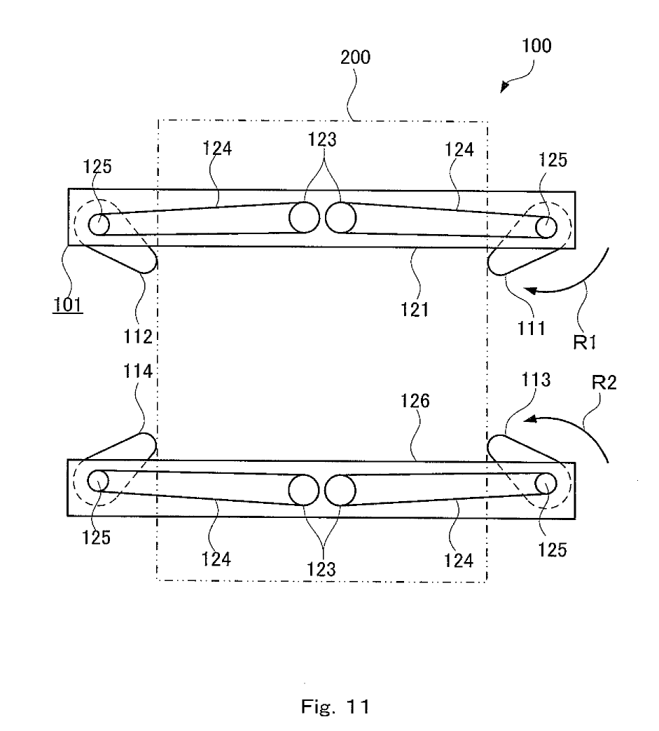

As shown in FIG. 11, with respect to a direction R1 in which the first clamping mechanism 121 rotates the first member 111, the second clamping mechanism 126 may rotate the third member 113 in an opposite direction; namely, R2.

Hence, this structure produces the biting effect on (i) the third member 113 and the fourth member 114 when the load 200 is lifted, and (ii) the first member 111 and the second member 112 when the load 200 is taken down. This structure is capable of exercising the biting effect when the transfer device 100 takes down the load 200, as well as clamps to lift the load 200. Accordingly, the transfer device 100 can exercise the biting effect throughout its operation, and quickly transfer a load.

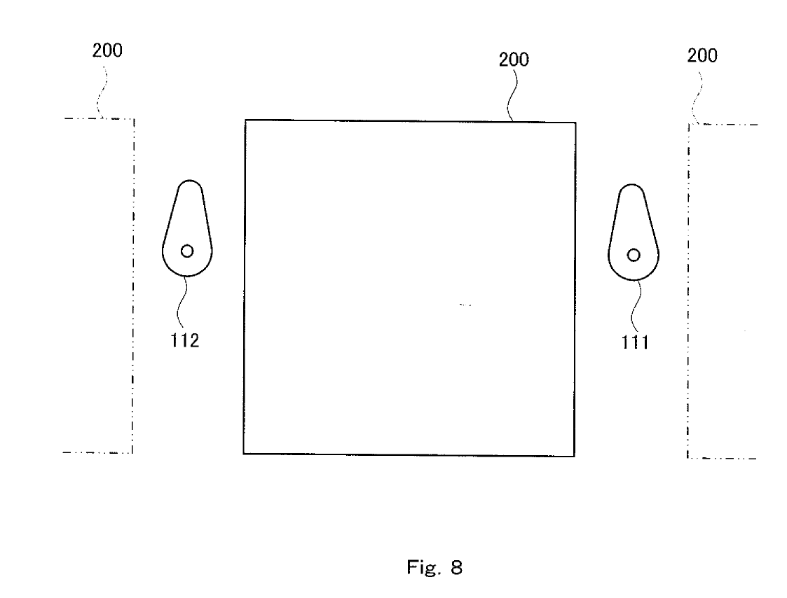

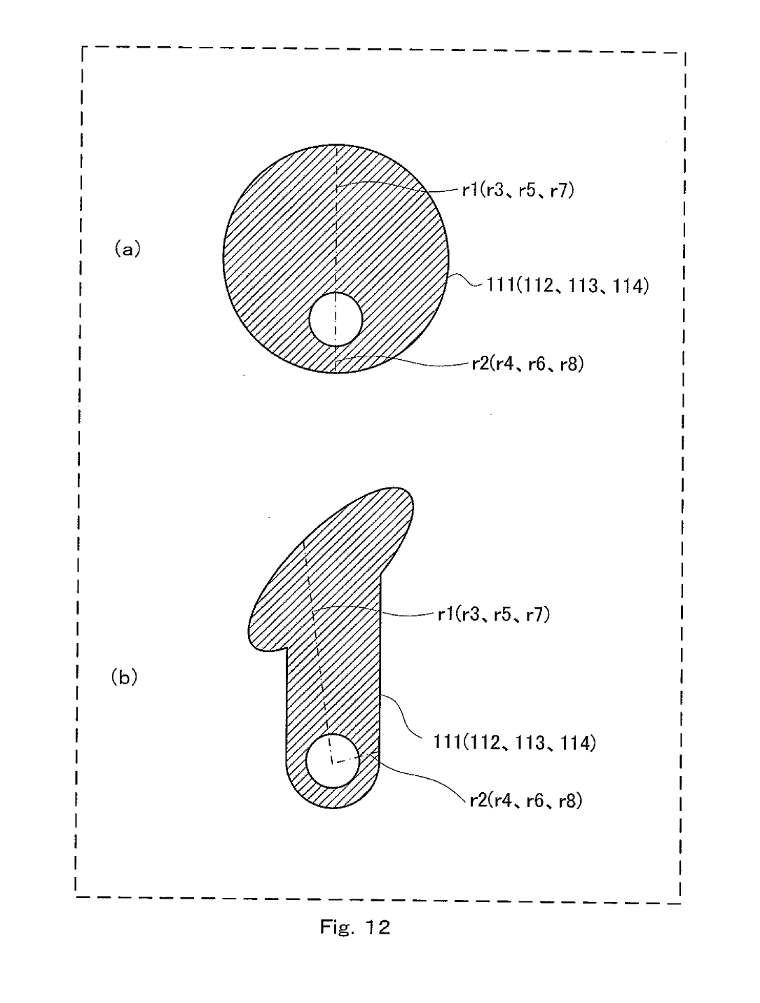

Profiles of the first member 111, the second member 112, the third member 113, and the fourth member 114 shall not be limited to the one shown in FIGS. 2 to 11. For example, the first member 111, the second member 112, the third member 113, and the fourth member 114 may have profiles shown in FIG. 12. The first member 111, the second member 112, the third member 113, and the fourth member 114 may be shaped angular instead of a circle as far as they rotate to increase the distance between themselves and a load.

Although only an embodiment of this invention have been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The present invention is used in a factory or in an automated warehouse where an automated transfer vehicle transfers a load from a predetermined place to another place.

What is claimed is:

1. A transfer device which transfers a clamped load, said device comprising:
a first member which is attached so as to rotate about an axis of rotation perpendicular to a horizontal direction in which the load is clamped, and makes contact with the load, said first member having a profile with (i) a first radius stretching from the axis of rotation to a periphery of said first member, and (ii) a second radius being shorter than the first radius;
a second member which clamps the load by working together with said first member; and
a first clamping mechanism which (i) rotates said first member about the axis of rotation so that a distance between an end portion of the first radius and said second member diminishes, and (ii) produces a clamping force for clamping the load.

2. The transfer device according to claim 1, further comprising:
a third member which (i) is placed either above or below said first member and said second member, (ii) is attached so as to rotate about an axis of rotation perpendicular to a horizontal direction in which the load is clamped, and (iii) makes contact with the load, said third member having a profile with (i) a third radius stretching from the axis of rotation to a periphery of said third member, and (ii) a fourth radius being shorter than the third radius;
a fourth member which clamps the load by working together with said third member; and
a second clamping mechanism which (i) rotates said third member about the axis of rotation so that a distance between an end portion of the third radius and said fourth member diminishes, and (ii) produces a clamping force for clamping the load.

3. The transfer device according to claim 2,
wherein said first member of said first clamping mechanism and said third member of said second clamping mechanism rotate in opposite directions.

4. The transfer device according to claim 1, further comprising:
an adjusting mechanism adjusting a distance lying between said first member and said second member.

5. A transfer method which employs a transfer device that transfers a clamped load and includes: a first member which is attached so as to rotate about an axis of rotation perpendicular to a horizontal direction in which the load is clamped, and makes contact with the load, the first member having a profile with (i) a first radius stretching from the axis of rotation to a periphery of the first member, and (ii) a second radius being shorter than the first radius; and a second member which clamps the load by working together with the first member,
wherein said transfer method involves (i) rotating the first member about the axis of rotation in a direction so that an end portion of the first radius travels from above the axis toward the load, and (ii) producing a clamping force above the axis to clamp and transfer the load. A transfer device which transfers a clamped load, said device comprising:
a first member which is attached so as to rotate about an axis of rotation perpendicular to a horizontal direction in which the load is clamped, and makes contact with the load, said first member having a profile with (i) a first radius stretching from the axis of rotation to a periphery of said first member, and (ii) a second radius being shorter than the first radius;
a second member which clamps the load by working together with said first member; and
a first clamping mechanism which (i) rotates said first member about the axis of rotation so that a distance between an end portion of the first radius and said second member diminishes, and (ii) produces a clamping force for clamping the load.
